(19) United States
(12) Patent Application Publication
(10) Pub. No.: US 2011/0051701 A1
(43) Pub. Date: Mar. 3, 2011

(54) IMS DEREGISTRATION OF A DUAL MODE DEVICE TRIGGERED THROUGH A LEGACY NETWORK

(76) Inventors: Yigang Cai, Naperville, IL (US); Suzann Hua, Lisle, IL (US)

(21) Appl. No.: 12/549,072

(22) Filed: Aug. 27, 2009

(51) Int. Cl. H04W 60/00

(52) U.S. Cl. 370/338; 455/466

(57) ABSTRACT

Systems and methods are disclosed that deregister a dual mode device with an IMS network by transmitting a message over a legacy network (e.g., a cellular network). The dual mode device detects a loss of wireless communications with an access network of the IMS network, and transmits a deregister request message to the legacy network for delivery to the IMS network. A network element in the IMS network receives the deregister request message, and updates an IMS registration status of the dual mode device based on the deregister request message to indicate the dual mode device as deregistered.

### BACKGROUND

1. Field of the Invention

The invention is related to the field of communications and, in particular, to de-registration of a dual mode device in an IMS network.

2. Statement of the Problem

One type of communication network gaining popularity is an IP Multimedia Subsystem (IMS) network. As set forth in the 3^{rd} Generation Partnership Project (3GPP), the IMS is a core network that provides multimedia services to user equipment (UE) over an Internet Protocol (IP) network. The IMS network is able to communicate with UE through different types of access networks, such as a Wide Local Area Network (WLAN) (e.g., a WiFi or a WiMAX network), an Ethernet network, a High Rate Packet Data (HRPD) network, or another type of access network. Service providers are accepting the IMS architecture in next generation network evolution.

Before the UE receives service from IMS network, the UE attempts to register with the IMS network through the appropriate access network. To register according to 3GPP standards, the UE transmits a register request message, such as a Session Initiation Protocol (SIP) REGISTER message, to a Serving-Call Session Control Function (S-CSCF) in the IMS network. Responsive to receiving the register request message, the S-CSCF generates an authentication request message, such as a Diameter Multimedia Authentication Request (MAR) message, and transmits the authentication request message to a Home Subscriber Server (HSS). The HSS then authenticates the UE, such as through the Authentication and Key Agreement (AKA) authentication method. If the UE is authenticated, then the HSS updates the IMS registration status of the UE as “registered” in the subscriber profile for the UE. The S-CSCF then typically requests the subscriber profile of the UE by sending a Diameter Server Assignment Request (SAR) message to the HSS. In response, the HSS sends the subscriber profile for the UE to the S-CSCF in a Diameter Server Assignment Answer (SAA) message. The S-CSCF thus knows the UE is presently registered based on the IMS registration status in the subscriber profile.

The HSS maintains a SIP registration timer for the UE. In order to remain registered with the IMS network, the UE needs to re-register periodically before the SIP registration timer expires. If the UE fails to re-register in time, the HSS will automatically deregister the UE.

Wireless phone providers are developing dual mode devices that have the functionality for communicating with a legacy network (e.g., a cellular network) and other types of wireless data networks, such as an IMS network. The concept of the dual mode device is to allow a user the flexibility to communicate with either the legacy network or the IMS network.

When a dual mode device is in range of the legacy network, the dual mode device registers with the legacy network to receive communication access. Likewise, when the dual mode device is in range of the IMS access network, the dual mode device registers with IMS network as described above. During the registration process, network resources are reserved for the dual mode device.

After registration, the dual mode device may communicate over either network until such time as the dual mode device is deregistered and network resources are released for each respective network. The dual mode device may actively deregister with the IMS network while it is in range of the IMS network. When the dual mode device moves out of range of the IMS network, the status of the dual mode device within the IMS network remains “registered” until the SIP registration timer expires.

### SUMMARY

Embodiments described herein deregister a dual mode device in an IMS network by sending messages over a legacy network, when the dual mode device loses communication with the IMS access network. Support of accurate IMS registration status for a dual mode device is typically difficult due the mobility of the device while accurate IMS registration status of the dual mode device is desirable in order to support smooth handover between the IMS network and the legacy network and to conserve network resources. For example, a problem arises when the dual mode device loses communication with the IMS access network, such as when the dual mode device moves out of the service area of the IMS access network. When communication with the IMS access network is lost, the dual mode device cannot actively deregister with the IMS network. Therefore, the status of the dual mode device within the IMS network remains “registered” until the SIP registration timer expires. If the IMS network were to receive a session initiation request (i.e., SIP INVITE) before the SIP registration timer expires, the S-CSCF that is serving the dual mode device may attempt to set up the call/session to the dual mode device because it is still indicated as registered even though the dual mode device has move out of range. As the dual mode device is no longer in range of the IMS access network, call set up over the IMS network will fail and the call set up will be redirected to the legacy network. This unfortunately delays set up time and wastes network resources.

For example, the dual mode device may send a deregistration SMS message to the IMS network through the legacy network, which causes the IMS network to deregister the dual mode device. Thus, even though the dual mode device cannot communicate directly with the IMS network, the dual mode device may trigger deregistration in the IMS network over the legacy network before the SIP registration timer expires. This advantageously reduces call initiation times, and saves network resources in the IMS network.

One embodiment comprises a dual mode device. The dual mode device includes a network interface operable to exchange wireless communications with an access network of an IMS network, and to exchange wireless communications with a legacy network, such as a cellular network. The dual mode device further includes a deregistration system operable to detect a loss of wireless communications with the access network of the IMS network. In response to detecting the loss of wireless communications, the deregistration system is further operable to generate a deregister request message (e.g., an SMS message) to deregister the device in the IMS network, and to transmit the deregister request message to the legacy network through the network interface for delivery to the IMS network.

Another embodiment comprises a network element in the IMS network. The network element includes an interface system operable to receive the deregister request message from the legacy network that was sent from the dual mode device. The network element further includes a registration system operable to update an IMS registration status of the dual mode device based on the deregister request message to indicate the dual mode device as deregistered.

In yet another embodiment, the network element further includes a notification system operable to identify one or more other network elements in the IMS network that maintains an IMS registration status for the dual mode device, and to send a deregistration notification message to the network element(s) indicating that the dual mode device is deregistered.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a communication network in an exemplary embodiment.

FIG. 2 illustrates a dual mode device in an exemplary embodiment.

FIG. 3 is a flow chart illustrating a method of operating a dual mode device to initiate deregistration in an IMS network in an exemplary embodiment.

FIG. 4 illustrates a network element of an IMS network in an exemplary embodiment.

FIG. 5 is a flow chart illustrating a method of deregistering a dual mode device in an IMS network in an exemplary embodiment.

FIG. 6 illustrates another communication network in an exemplary embodiment.

FIG. 7 is a message diagram illustrating deregistration of a dual mode device in an IMS network using a cellular network in an exemplary embodiment.

FIG. 8 is another message diagram illustrating deregistration of a dual mode device in an IMS network using a cellular network in another exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

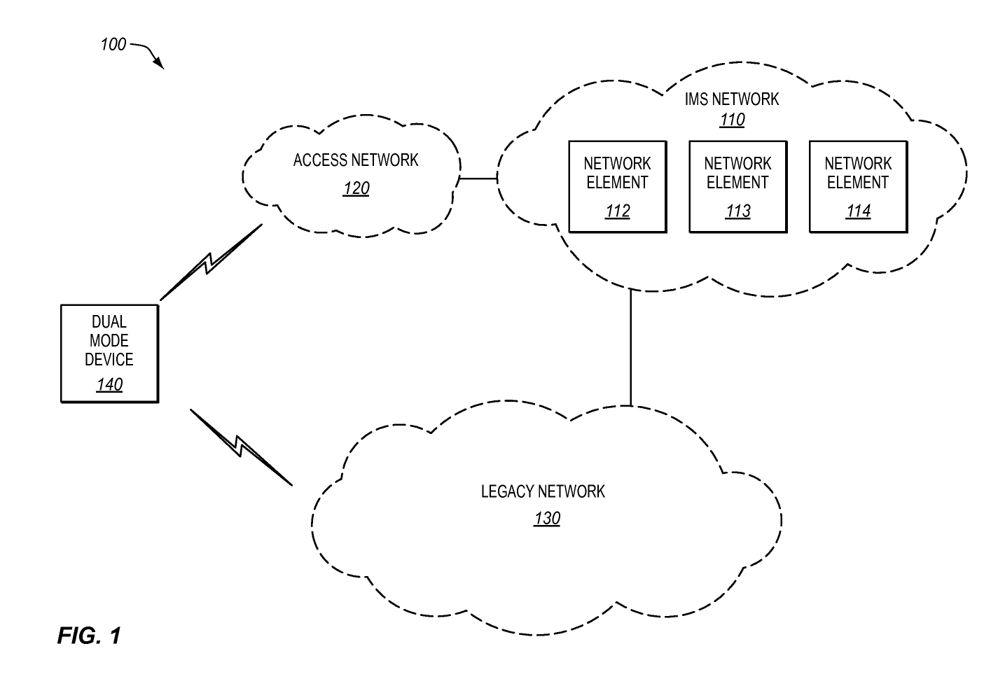

FIG. 1 illustrates a communication network 100 in an exemplary embodiment of the invention. Communication network 100 includes an IMS network 110 and access network 120 for IMS network 110. IMS network 110 is a core network adapted to deliver Internet Protocol (IP) multimedia services. The IMS architecture allows for a variety of different access types for IMS devices. In this embodiment, access to IMS network 110 is provided through access network 120. Access network 120 comprises any type of network adapted to communicate through wireless signals. Some examples of access network 120 include a WiFi network, a WiMAX network, an HRPD network, etc.

IMS network 110 is generally shown as including a plurality of network elements 112-114. One of network elements 112-114 may represent a Serving-Call Session Control Function (S-CSCF). Likewise, one or more of network element 112-114 may represent application servers. One of network elements 112-114 may represent an IMS subscriber server that stores profiles for IMS subscribers, such as a Home Subscriber Server (HSS). The network elements 112-114 in IMS network 110 are labeled generally because the operations described in the following flow charts may be performed in different types of network elements. One common feature of network elements 112-114 is that they know or maintain an IMS registration status of IMS devices. For example, an HSS maintains subscriber profiles that indicate the IMS registration status of IMS devices. An S-CSCF maintains an IMS registration status of IMS devices that it is serving. Application servers provide services to IMS devices that are presently registered.

Communication network 100 further includes a legacy network 130. Legacy network 130 comprises any non-IMS mobile network adapted to provide mobile communication services. Examples of legacy network 130 include a Code Division Multiple Access (CDMA) network and a Global System for Mobile communications (GSM) network. “Legacy” is not intended to refer to only networks presently existing, but also to non-IMS networks that are developed in the future, such as new cellular networks. Although not shown, those skilled in the art will appreciate that legacy network 130 may include a Radio Access Network (RAN), a Mobile Switching Center (MSC), a Short Message Service Center (SMSC), a subscriber server (such as a Home Location Register (HLR)), etc.

The network clouds illustrating access network 120 and legacy network 130 are not being used to show the actual service areas of the networks, as the service areas may be separate or may overlap. IMS network 110 and legacy network 130 are separate networks, but both networks 110 and 130 may be managed or owned by a common service provider.

IMS network 110 and legacy network 130 are both adapted to provide communication services to a dual mode device 140. Dual mode device 140 comprises any type of communication device adapted to communicate with both an IMS network and a legacy network. For example, dual mode device 140 may be SIP-enabled, and is able to communicate with IMS network 110 through a WiFi connection. At the same time, dual mode device 140 may be a CDMA device that is able to communicate with a CDMA network.

If dual mode device 140 is in range of access network 120, then dual mode device 140 registers with IMS network 110 through access network 120. When registered with IMS network 110, dual mode device 140 is able to access services provided by IMS network 110, such as voice calls, video downloads, audio downloads, gaming, etc. Similarly, if dual mode device 140 is in range of legacy network 130, then dual mode device 140 registers with legacy network 130. When registered with legacy network 130, dual mode device 140 is able to access services provided by legacy network 130, such as voice calls, SMS, etc. If dual mode device 140 is in range of both access network 120 and legacy network 130, then dual mode device 140 may register with one or both of the networks depending on design preferences.

In FIG. 1, assume that dual mode device 140 is in range of access network 120 and is registered with IMS network 110. At some point after registering with IMS network 110, further assume that dual mode device 140 loses communication with access network 120. When this occurs, dual mode device 140 is no longer able to communicate with IMS network 110, but is still registered with IMS network 110. This can be a problem as IMS network 110 may continue to attempt to connect calls to dual mode device 140 even though it is out of range of access network 120. According to the embodiments described below, dual mode device 140 communicates with IMS network 110 over legacy network 130 to deregister itself in IMS network 110.

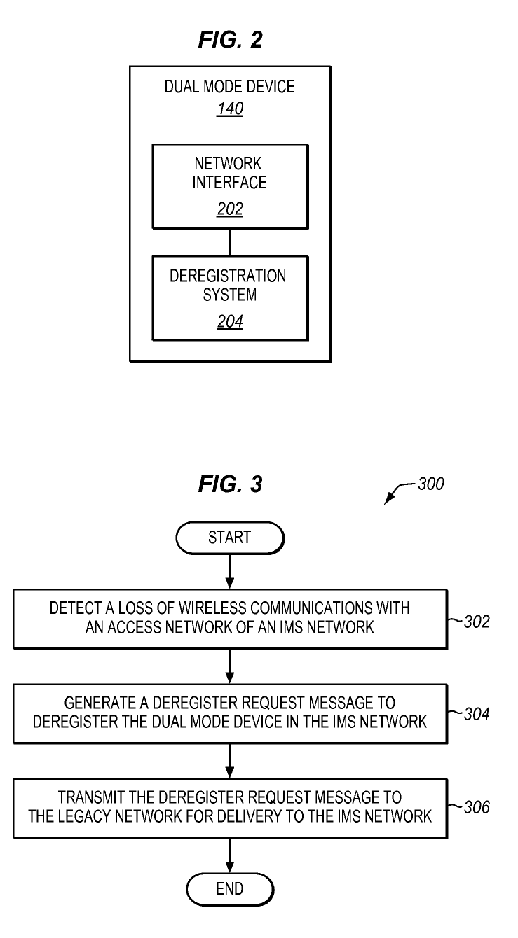

FIG. 2 illustrates dual mode device 140 in an exemplary embodiment. In this embodiment, dual mode device 140 includes a network interface 202 and a deregistration system 204. Network interface 202 comprises any device, component, or system adapted to exchange wireless communications with access network 120 of IMS network 110, and to exchange wireless communications with legacy network 130. Deregistration system 204 comprises any device, component, or system adapted to initiate a deregistration process to deregister dual mode device 140 in IMS network 110 by communicating over legacy network 130. One exemplary operation of dual mode device 140 is illustrated in FIG. 3.

FIG. 3 is a flow chart illustrating a method 300 of operating dual mode device 140 to initiate deregistration in IMS network 110 in an exemplary embodiment. The steps of method 300 will be described with reference to communication network 100 in FIG. 1 and dual mode device 140 in FIG. 2, but those skilled in the art will appreciate that method 300 may be performed in other networks and systems. Also, the steps of the flow charts described herein are not all inclusive and may include other steps not shown, and the steps may be performed in an alternative order.

In step 302, deregistration system 204 detects a loss of wireless communications with access network 120 of IMS network 110. The loss of wireless communications may be due to a failure of an access point in access network 120, due to dual mode device 140 moving out of the coverage area of access network 120, etc. In response to detecting the loss of wireless communications, deregistration system 204 generates a deregister request message to deregister dual mode device 140 in IMS network 110 in step 304. A deregister request message comprises any message that instructs or causes IMS network 110 to terminate registration for a device. Deregistration system 204 may format the deregister request message with a teleservice ID, a service type, a content type, or some other parameter requesting deregistration in IMS network 110. The deregister request message is in a protocol for transmission over legacy network 130 instead of over IMS network 110. For example, deregistration system 204 may generate a Short Message Service (SMS) message in a signaling protocol used for transmission over legacy network 130. In step 306, deregistration system 204 transmits the deregister request message to legacy network 130 through network interface 202 for delivery to IMS network 110.

In FIG. 1, legacy network 130 receives the deregister request message from dual mode device 140, and delivers the deregister request message to IMS network 110 so that the IMS registration status of dual mode device 140 can be updated to “not registered”. Those skilled in the art will appreciate that legacy network 130 may alter or change the deregister request message that was initially sent by dual mode device 140. For example, if dual mode device 140 sent an SMS message, legacy network 130 may change the SMS message to a Short Message Point-to-Point (SMPP) message, a Lightweight Directory Access Protocol (LDAP) message, etc.

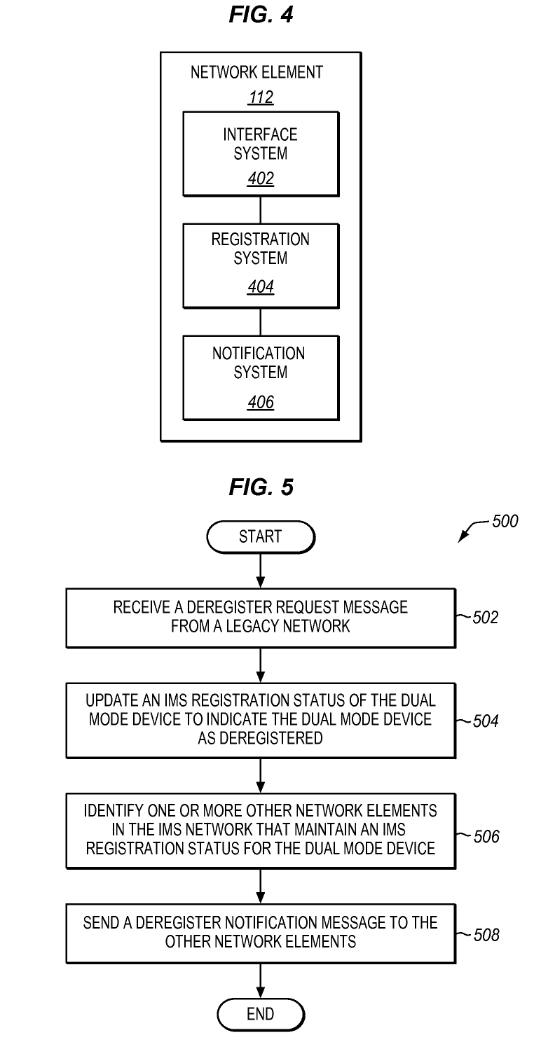

One of network elements 112-114 will receive the deregister request message that was delivered over legacy network 130, such as network element 112. FIG. 4 illustrates network element 112 in an exemplary embodiment. Network element 112 may represent an HSS in IMS network 110, an application server in IMS network 110, or another type of network element. In this embodiment, network element 112 includes an interface system 402, a registration system 404, and a notification system 406. Interface system 402 comprises any device, component, or system adapted to receive messages from legacy network 130. For example, interface system 402 may comprise an SMPP interface, an LDAP interface, etc. Registration system 404 comprises any device, component, or system adapted to maintain an IMS registration status of dual mode device 140, such as “registered” or “not registered”. Notification system 406 comprises any device, component, or system adapted to notify other network elements in IMS network 110 of a change to the IMS registration status of dual mode device 140. One exemplary operation of network element 112 is illustrated in FIG. 5.

FIG. 5 is a flow chart illustrating a method 500 of deregistering dual mode device 140 in IMS network 110 in an exemplary embodiment. The steps of method 500 will be described with reference to communication network 100 in FIG. 1 and network element 112 in FIG. 4, but those skilled in the art will appreciate that method 500 may be performed in other networks and systems.

In step 502, interface system 402 receives the deregister request message from legacy network 130. The deregister request message received from legacy network 130 may comprise an SMPP message, an LDAP message, etc. The deregister request message includes a parameter or code instructing dual mode device 140 to be deregistered in IMS network 110, such as a service type parameter, a content type parameter (in SIP), etc. The parameter may be inserted in the deregister request message by dual mode device 140 or legacy network 130, such as by an SMSC in legacy network 130. In step 504, registration system 404 updates the IMS registration status for dual mode device 140 based on the deregister request message to indicate dual mode device 140 as deregistered or not registered. For example, registration system 404 may process the service type parameter or content type parameter to update the IMS registration status.

There may be other network elements 113-114 in IMS network 110 that are serving dual mode device 140, and thus also maintain an IMS registration status for dual mode device 140. Thus, in response to the update to the IMS registration status, notification system 406 may identify one or more other network elements 113-114 that maintain an IMS registration status for dual mode device 140 in step 506. Notification system 406 may then send a deregistration notification message to the other network element(s) 113-114 in IMS network 110 indicating that dual mode device 140 is deregistered in step 508. The network element(s) 113-114 receiving the deregistration notification message can likewise update the IMS registration status for dual mode device 140. The goal is that each network element in IMS network 110 that is/was serving dual mode device 140 knows that dual mode device 140 is now deregistered so that they do not waste network resources in setting up a call to dual mode device 140 or providing some other unneeded service.

If dual mode device 140 is again able to exchange wireless communications with access network 120 of IMS network 110, then dual mode device 140 may again register with IMS network 110. Each time dual mode device 140 detects a loss of wireless communications with access network 120, dual mode device 140 may initiate the deregistration process with IMS network 110 over legacy network 130.

### EXAMPLE

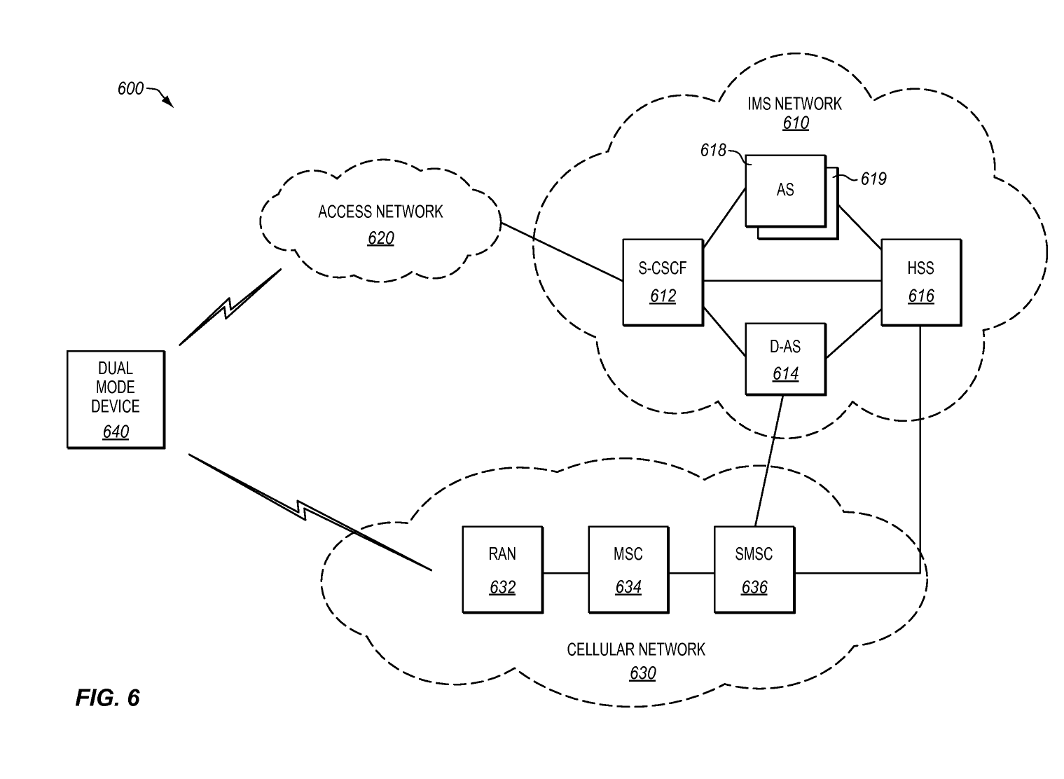

FIG. 6 illustrates another communication network 600 in an exemplary embodiment. Like FIG. 1, communication network 600 includes an IMS network 610 and access network 620 operable to provide communication service to a dual mode device 640. Communication network 600 also includes a cellular network 630 operable to provide communication service to dual mode device 640.

In this embodiment, IMS network 110 includes a Serving-Call Session Control Function (S-CSCF) 612, a deregistration application server (D-AS) 614, a Home Subscriber Server (HSS) 616, and application servers (AS) 618-619. S-CSCF 612 is adapted to set up and maintain calls/sessions involving dual mode device 640 over IMS network 610. Deregistration application server 614 is a specialized server designated for deregistering devices based on messages received over cellular network 630 (or another type of legacy network). Deregistration application server 614 is optional is this embodiment, which will be shown in more detail below. HSS 616 is adapted to store a subscriber profile for dual mode device 640. The subscriber profile for dual mode device 640 includes a variety of information for dual mode device 640, such as service subscriptions and billing, and an IMS registration status. The IMS registration status for dual mode device 640 may indicate “registered” or “not registered”. Application servers 618-619 are adapted to provide services or features to dual mode device 640, such as voice mail, call forwarding, video downloads, gaming, etc.

Cellular network 630 may comprise a CDMA network, a GSM/UMTS network, or some other cellular network. Cellular network 630 is one example of a “legacy network” described in FIG. 1. In this embodiment, cellular network 630 includes a Radio Access Network (RAN) 632, a Mobile Switching Center (MSC) 634, and a Short Message Service Center (SMSC) 636.

During any given time, multiple network elements in IMS network 610 may maintain an IMS registration status for dual mode device 640. For example, S-CSCF 612 needs to know whether or not dual mode device 640 is registered. Likewise, if application server 618 is providing a service to dual mode device 640, then application server 618 needs to know whether or not dual mode device 640 is registered. Not all network elements in IMS network 610 may store an internal record of the IMS registration status as does HSS 616. For example, application servers 618-619 may subscribe to HSS 616 to be notified if dual mode device 640 deregisters, but do not store their own IMS registration status record. However, each network element that needs to know whether or not dual mode device 640 is registered is generally referred to herein as “maintaining” an IMS registration status.

Assume for this example that dual mode device 640 registers with IMS network 610. Thus, the subscriber profile stored in HSS 616 indicates that dual mode device 640 is “registered”. At some point after registering with IMS network 610, further assume that dual mode device 640 loses communication with access network 620. When this occurs, dual mode device 640 is no longer able to communicate with IMS network 610, but is still registered with IMS network 610. According to the example described below, dual mode device 640 communicates with IMS network 610 over cellular network 630 to deregister itself in IMS network 610.

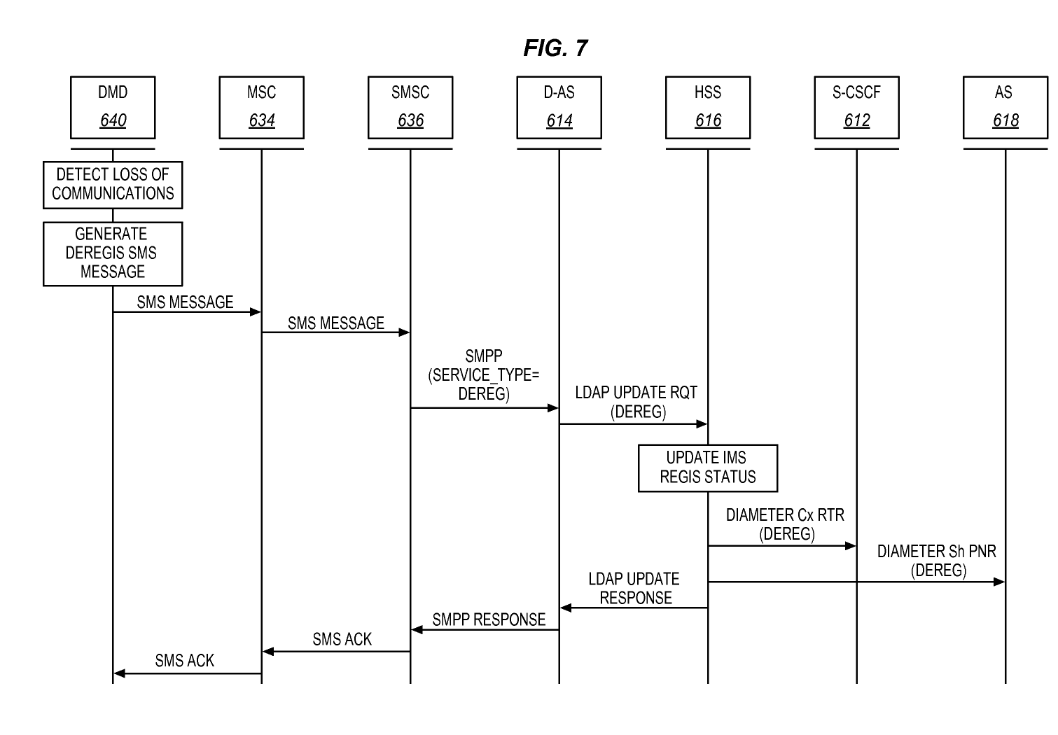

FIG. 7 is a message diagram illustrating deregistration of dual mode device 640 in IMS network 610 using cellular network 630 in an exemplary embodiment. Dual mode device (DMD) 640 detects the loss of wireless communications with access network 620. In response to detecting the loss of wireless communications, dual mode device 640 generates a “deregistration” SMS message for deregistering itself in IMS network 610. Dual mode device 640 identifies a teleservice ID (e.g., 4242) that instructs or indicates deregistration, and inserts the teleservice ID in a parameter of the SMS message. Dual mode device 640 may also identify a routing address for the destination of the SMS message, which may be the directory number of deregistration application server (D-AS) 614, and insert the routing address in the SMS message. Dual mode device 640 then sends the SMS message to cellular network 630 in the proper signaling message.

MSC 634 receives the SMS message (through RAN 632 in FIG. 6), and forwards the SMS message to SMSC 636 (i.e., in an SMDPP message, a MAP message, etc). SMSC 636 processes the SMS message to identify the teleservice ID and the routing address, and converts the teleservice ID to a service type (e.g., service_type=dereg). SMSC 636 then generates an SMPP message, and inserts the service type in a parameter of the SMPP message. With the message properly formatted, SMSC 636 sends the SMPP message to deregistration application server 614 based on the routing address.

Deregistration application server 614 receives the SMPP message, and processes the service type parameter in the SMPP message. Because the service type parameter represents an instruction to deregister dual mode device 640, deregistration application server 614 generates an LDAP update message with an instruction to update the IMS registration status to “not registered”. Deregistration application server 614 then sends the LDAP update message to HSS 616. Upon receiving the LDAP update message, HSS 616 updates the IMS registration status in the subscriber profile of dual mode device 640 to indicate “not registered”.

HSS 616 also notifies other network elements in IMS network 610 that dual mode device 640 is no longer registered. To do so, HSS 616 identifies the other network elements that maintain an IMS registration status for dual mode device 640. As an example, S-CSCF 612 and application server 618 may subscribe to HSS 616 (such as with a SIP SUBSCRIBE) to be notified of a change to the registration status of dual mode device 640. Thus, HSS 616 sends a Diameter Cx Registration Termination Request (RTR) message to S-CSCF 612 indicating that dual mode device 140 is deregistered. HSS 616 also sends a Diameter Sh Push Notification Request (PNR) to application server 618 indicating that dual mode device 140 is deregistered. The remaining messages in FIG. 7 are response messages that do not need further explanation.

As is evident in FIG. 7, dual mode device 640 is advantageously able to update its IMS registration status in HSS 616 by sending an SMS message to IMS network 610 through cellular network 630. HSS 616 is then able to notify other network elements in IMS network 610 that dual mode device 640 is not registered. Advantageously, S-CSCF 612, application server 618, and other network elements know that dual mode device 640 is no longer registered so that they do not waste network resources in attempting to set up a call to dual mode device 640 or provide other services.

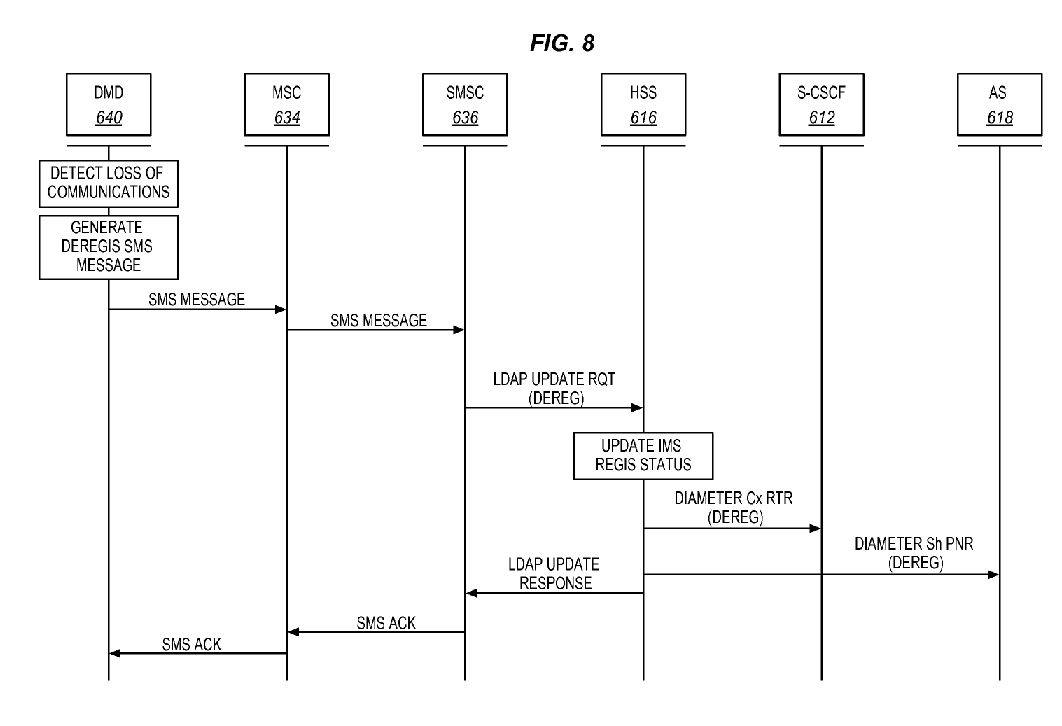

FIG. 8 is another message diagram illustrating deregistration of dual mode device 640 in IMS network 610 using cellular network 630 in an exemplary embodiment. In this example, SMSC 636 contacts HSS 616 directly to update the IMS registration status of dual mode device 640. FIG. 8 is similar to FIG. 7 until SMSC 636 receives SMS message from MSC 634.

In response to receiving the SMS message, SMSC 636 processes the SMS message to identify the teleservice ID and the routing address, and converts the teleservice ID to a service type (e.g., service_type=dereg). In this embodiment, the routing address indicates that HSS 616 is the intended recipient of the SMS message. Thus, SMSC 636 generates an LDAP update message with an instruction to update the IMS registration status to “not registered”. SMSC 636 then sends the LDAP update message to HSS 616 based on the routing address. Upon receiving the LDAP update message, HSS 616 updates the IMS registration status in the subscriber profile of dual mode device 640 to indicate “not registered”. HSS 616 also notifies other network elements in IMS network 610 that dual mode device 640 is no longer registered similar to FIG. 7.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. A network element of an IP Multimedia Subsystem (IMS) network, comprising:
an interface system configured to receive a deregister request message from a legacy network that was sent from a dual mode device which lost wireless communications with an access network of the IMS network; and
a registration system configured to update an IMS registration status of the dual mode device based on the deregister request message to indicate the dual mode device as deregistered.

2. The network element of claim 1 further comprising:
a notification system configured to identify at least one other network element in the IMS network that maintains an IMS registration status for the dual mode device, and to send a deregistration notification message to the at least one other network element indicating that the dual mode device is deregistered.

3. The network element of claim 2 wherein:
the at least one other network element comprises a Serving Call Session Control Function (S-CSCF) in the IMS network; and
the notification system is further configured to send a Diameter Cx message to the S-CSCF indicating that the dual mode device is deregistered.

4. The network element of claim 2 wherein:
the at least one other network element comprises an application server in the IMS network; and
the notification system is further configured to send a Diameter Sh message to the application server indicating that the dual mode device is deregistered.

5. The network element of claim 1 wherein:
the interface system is further configured to receive the deregister request message from a Short Message Service Center (SMSC) in the legacy network which received an SMS message from the dual mode device requesting deregistration.

6. The network element of claim 5 wherein:
the deregister request message includes a service type parameter set by the SMSC to deregister the dual mode device.

7. The network element of claim 5 wherein:
the deregister request message received from the SMSC comprises a Short Message Point-to-Point (SMPP) message.

8. The network element of claim 5 wherein:
the deregister request message received from the SMSC comprises a Lightweight Directory Access Protocol (LDAP) message.

9. A method comprising:
receiving, in an IP Multimedia Subsystem (IMS) network element, a deregister request message from a legacy network that was sent from a dual mode device which lost wireless communications with an access network of an IP Multimedia Subsystem (IMS) network; and
updating an IMS registration status of the dual mode device based on the deregister request message to indicate the dual mode device as deregistered.

10. The method of claim 9 further comprising:
identifying at least one other network element in the IMS network that maintains an IMS registration status for the dual mode device; and
sending a deregistration notification message to the at least one other network element indicating that the dual mode device is deregistered.

11. The method of claim 10 wherein:
the at least one other network element comprises a Serving Call Session Control Function (S-CSCF) in the IMS network; and
sending a deregistration notification message comprises sending a Diameter Cx message to the S-CSCF indicating that the dual mode device is deregistered.

12. The method of claim 10 wherein:
the at least one other network element comprises an application server in the IMS network; and
sending a deregistration notification message comprises sending a Diameter Sh message to the application server indicating that the dual mode device is deregistered.

13. The method of claim 9 wherein receiving a deregister request message from a legacy network comprises:
receiving the deregister request message from a Short Message Service Center (SMSC) in the legacy network which received an SMS message from the dual mode device requesting deregistration.

14. The method of claim 13 wherein:
the deregister request message includes a service type parameter set by the SMSC to deregister the dual mode device.

15. The method of claim 13 wherein:
the deregister request message received from the SMSC comprises a Short Message Point-to-Point (SMPP) message.

16. The method of claim 13 wherein:
the deregister request message received from the SMSC comprises a Lightweight Directory Access Protocol (LDAP) message.

17. A device comprising:
a network interface configured to exchange wireless communications with an access network of an IP Multimedia Subsystem (IMS) network, and to exchange wireless communications with a legacy network; and
a deregistration system configured to detect a loss of the wireless communications with the access network of the IMS network, to generate a deregister request message to deregister the device in the IMS network in response to detecting the loss of the wireless communications, and to transmit the deregister request message to the legacy network through the network interface for delivery to the IMS network.

18. The device of claim 17 wherein:
the deregister request message comprises a Short Message Service (SMS) message.

19. The device of claim 18 wherein:
the deregistration system is further configured to identify a teleservice ID for deregistering the device in the IMS network, and to insert teleservice ID in the SMS message.

20. The device of claim 18 wherein:
the deregistration system is further configured to store a routing address for a network element in the IMS network that maintains an IMS registration status for the device, and to insert the routing address in the SMS message.
